(19) United States
(12) Patent Application Publication
(10) Pub. No.: US 2023/0153704 A1
(43) Pub. Date: May 18, 2023

(54) Business method and enabling software to manage autonomous independent & trusted suppliers in the provision of group adventure travel planning and execution

(71) Applicants: Paul Reiss, Hillsborough, NJ (US); Helen Reiss, Hillsborough, NJ (US)

(72) Inventors: Paul Reiss, Hillsborough, NJ (US); Helen Reiss, Hillsborough, NJ (US)

(21) Appl. No.: 17/993,856

(22) Filed: Nov. 23, 2022

Related U.S. Application Data
(60) Provisional application No. 63/360,986, filed on Nov. 17, 2021.

(51) Int. Cl. G06Q 10/02

(52) U.S. Cl. CPC G06Q 10/02

(57) ABSTRACT

Computer-implemented methods, systems and computer readable media for Group Activity Management And Monitoring Automation (GAMMA), are described.

### RELATED APPLICATIONS

This application claims the benefit of U.S. Application No. 63/360,986, entitled “Business Method and Enabling Software to Manage Autonomous Independent & Trusted Suppliers in the Provision of Group Adventure Travel Planning And Execution,” and filed on Nov. 17, 2021, which is incorporated herein by reference in its entirety.

### TECHNICAL FIELD

Embodiments relate generally to travel booking and management systems, and more particularly, to computer-implemented methods, systems and computer readable media for Group Activity Management And Monitoring Automation (GAMMA).

### BACKGROUND

As a travel provider's client base grows and trip bookings increase, the scale of group activity management and monitoring of the data may grow proportionately. Conventional software may not be efficient from the perspective of the travel provider. For example, while the reservation booking and trip preparatory processes may appear seamless to a client, the process may become excessively labor intensive for the staff of the travel provider. Processing may be managed manually in some cases and monitored via excel spreadsheets or other conventional solutions.

With the growth of a client base and increase in trip bookings, the scale of group activity management and monitoring of the data grows proportionately. Although, with conventional systems, the reservation booking and trip preparatory processes may appear seamless from the client's perspective, they had become excessively labor intensive for travel company staff. Processing was managed manually and monitored via excel spreadsheets. The company had reached the point in its growth where automation has become a necessity to maintain the level of quality clients are accustomed to. After searching for existing software and systems in the marketplace, it was determined that no satisfactory products were available to fill the company's needs. Thus, it was decided to develop a complete, proprietary system with functionality and feature sets not only appropriate for Amazon river fishing travel, but amenable to automating any group-oriented fishing, hunting or adventure travel business, or other travel businesses, as well. Client satisfaction and ease of use were key considerations while providing an up-to date technology to automate and enhance the administrative process.

Some implementations were conceived in light of the above-mentioned needs, problems and/or limitations, among other things.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Some implementations can include a computer-implemented method. The method can include obtaining, at a group activity management and monitoring automation system, a service template specifying one or more deliverable components, where each of the one or more deliverable components includes one or more of a provider, a provider class, a description, and one or more parameters of that deliverable component. The method can also include generating, at the group activity management and monitoring automation system, an event record based on the service template, where the event record corresponds to an event and includes a specification of the one or more deliverable components from the template and a date range of the event. The method can further include storing, using the group activity management and monitoring automation system, the event record.

The method can also include associating, at the group activity management and monitoring automation system, a service provider with one of the one or more deliverable components of the event, and receiving, at the group activity management and monitoring automation system, a customer record including profile information. The method can further include generating, using the group activity management and monitoring automation system, a reservation for the event associated with the customer record, and storing, using the group activity management and monitoring automation system, the reservation for the event. The method can also include transmitting, from the group activity management and monitoring automation system, at least a portion of the customer record to the service provider to permit the service provider to provide one of the one or more deliverable components during the date range of the event.

In some implementations, the one or more deliverable components can each include one or more of a service or a product. In some implementations, the one or more deliverable components can each include one or more of a sales agent service, a booking agent service, a customer interface service, a travel agency service, a hotel service, an airport ground transportation service, a vehicle service, a camp service, a catering service, a housekeeping service, a guide service, a host service, equipment, a permitting service, a concierge service, a financial service, an insurance service, and a legal service.

The method can further include providing, from the group activity management and monitoring automation system, a customer portal configured to accept data for the customer record and display data from the customer record, where the customer record includes one or more of data representing the customer profile, questionnaire answers, signed waivers, and an acknowledgement of terms and conditions.

The method can also include providing, at the group activity management and monitoring automation system, a bidirectional communication system to permit the service provider to communicate with the group activity management and monitoring automation system to access the customer record and to provide status and completion information corresponding to the event. In some implementations, the bidirectional communication system includes one or more of email, portal, physical mail, telephone, human operator, or web interface.

The method can also include providing, from the group activity management and monitoring automation system, a management dashboard configured to provide a dashboard user interface of one or more data items within the group activity management and monitoring automation system corresponding to one or more events, suppliers, or customers. In some implementations, the group activity management and monitoring automation system is configured to store financial, administrative, and legal information related to a customer, a supplier, or an event in a database of the group activity management and monitoring automation system.

In some implementations, generating an event record based on the service template is performed one or more times based on a schedule or on demand, wherein the group activity management and monitoring automation system determines a capacity for events and permits event records to be generated for which there is a sufficient capacity of deliverable components to meet requirements of the generated event records.

The method can further include providing, from the group activity management and monitoring automation system, a listing of services offered and corresponding descriptions via a customer facing user interface. The method can also include receiving, at the group activity management and monitoring automation system, an electronic payment for the event, wherein the electronic payment can include a partial payment or a full payment for an event or service for one or more customers.

The method can further include generating, using the group activity management and monitoring automation system, a plurality of reservations each for a respective customer of a plurality of customers, where the reservations are associated with the event record, and forming, using the group activity management and monitoring automation system, a group reservation including the plurality of customers and corresponding reservations. The method can also include assigning, using the group activity management and monitoring automation system, a confirmed status to the reservation.

The method can further include assigning, using the group activity management and monitoring automation system, a confirmed status to the group reservation. The method can also include assigning, using the group activity management and monitoring automation system, a tentative status to the reservation, where the one or more deliverable components are reserved based on the tentative reservation, and when the customer indicates confirmation of the tentative reservation, updating the reservation status to confirmed.

The method can also include assigning, using the group activity management and monitoring automation system, a tentative status to the group reservation, where the one or more deliverable components are reserved based on the tentative group reservation, and when the customer indicates confirmation of the tentative group reservation, updating the group reservation status to confirmed.

The method can further include assigning, using the group activity management and monitoring automation system, a limbo status to the reservation, where the one or more deliverable components are not reserved based on the limbo reservation, and when the customer indicates confirmation of the limbo reservation, updating the reservation status to confirmed and reserving the one or more deliverables if available for the event date range.

The method can also include assigning, using the group activity management and monitoring automation system, a limbo status to the group reservation, where the one or more deliverable components are not reserved based on the limbo group reservation, and when the customer indicates confirmation of the limbo group reservation, updating the group reservation status to confirmed and reserving the one or more deliverable components if available during the date range of the event corresponding to the limbo group reservation.

The method can further include creating, using the group activity management and monitoring automation system, a shadow reservation, for an individual customer or a group, wherein the shadow reservation is based on an original reservation, where the shadow reservation includes reservation details of the original reservation with a different date range from the original reservation, maintaining, in the group activity management and monitoring automation system, the original reservation and the shadow reservation, receiving, at the group activity management and monitoring automation system, an indication of a selection of the original reservation or the shadow reservation as a selected reservation. The method can also include, when the original reservation is the selected reservation, keeping, at the group activity management and monitoring automation system, the original reservation in the group activity management and monitoring automation system, and discarding, at the group activity management and monitoring automation system, the shadow reservation.

The method can further include, when the shadow reservation is the selected reservation, making, at the group activity management and monitoring automation system, the shadow reservation a confirmed reservation and updating a status of the shadow reservation from shadow to confirmed, cancelling, at the group activity management and monitoring automation system, the original reservation, and transmitting, from the group activity management and monitoring automation system, via the bidirectional communication system, a change notice to any suppliers associated with the one or more deliverable components indicating a change from the original reservation to the shadow reservation.

The method can also include receiving, at the group activity management and monitoring automation system, from a subject matter expert, event data including one or more of an event type, an event location, a customer type, and identification of one or more deliverable components and associated deliverable component details, and generating, at the group activity management and monitoring automation system, the event template based on the event data.

### BRIEF DESCRIPTION OF THE DRAWINGS

FIG. 1 is a block diagram of an example system and a network environment which may be used for one or more implementations described herein.

FIG. 2 is a flowchart showing an example GAMMA system and client, supplier, administrator, and staff interfaces in accordance with some implementations.

FIG. 3 is a diagram of an example administrative dashboard for a GAMMA system in accordance with some implementations.

FIG. 4 is a flowchart of an example travel event (or trip) creation process using a GAMMA system in accordance with some implementations.

FIG. 5 is a flowchart of an example automated travel process using a GAMMA system in accordance with some implementations.

FIG. 6 is a flowchart of an example reservation process using a GAMMA system in accordance with some implementations.

FIG. 7 is a flowchart of an example client process for a trip using a GAMMA system in accordance with some implementations.

FIG. 8 is a diagram showing the automation provided by a GAMMA system between clients and suppliers for a travel event based on a template in accordance with some implementations.

FIG. 9 is a diagram showing a shadow reservation automated process provided by a GAMMA system in accordance with some implementations.

FIG. 10 is a diagram of an example computing device configured for Group Activity Management And Monitoring Automation in accordance with at least one implementation.

### DETAILED DESCRIPTION

In some implementations, computer-implemented methods, systems and computer readable media for Group Activity Management And Monitoring Automation (or GAMMA) can include a combination of software, hardware and business methods forming a group travel planning system. In one example application, a group travel business, such as a guided fishing travel company, relies on expert knowledge of a guide and the coordination of trusted suppliers. Suppliers can be any resource necessary to create the experience for the customers and can range from porters to charter airlines.

To be effective, such a system also needs to include electronic interfaces to communicate with the customers (or clients) themselves. The customer or client interface can be provided by integrated e-commerce functions and built-in web-based functions to communicate with the customer, such as providing checklists for preparation and monitoring client compliance. In some implementations, the web-based interface can be configured to permit a client to book a trip.

In an illustrative example as used herein, GAMMA can be used to operate and manage an adventure travel operation in the Amazon river and rainforest. GAMMA is unique in that it provides flexibility in the interface to suppliers, who are offered maximum autonomy in how they interact with the GAMMA system. The current art in this field is to provide a critical path-based production planning style system and expect suppliers to interact on the terms of the system. GAMMA differs in that while providing a basic schedule, it notifies suppliers of upcoming work, provides details and expectations, but allows the suppliers to perform their own work, sometimes with their own systems for detailed execution.

The process begins with a subject matter expert (e.g., a guide) who creates a template of a proposed group travel event. The guide can repeat (or reuse) a previous template or build a new one. The guide builds the template by describing the event and the timeframe, and then organizing the suppliers that are needed to make the event happen. For example, suppliers can include, but are not limited to, 1. travel agent for air travel; 2. porters and customer reception at the staging point; 3. hotel at staging; 4. charter planes to destination; 5. wilderness camp; 6. catering; 7. adventure guides; 8. boat accommodations; 9. provision of adventure equipment; and 10. insurance, financial, and legal services, among other things.

This wide range of suppliers interacts with the system each in their preferred manner, as it is clear that a different style of interface is required for a jungle guide with satellite internet connection compared to a trusted travel agent in a city office setting.

GAMMA provides the trip and client information to the trusted suppliers and the suppliers are engaged to perform their functions without undue interference. The basic information conveyed to suppliers are the event definition, the timeframe, the customer identities, special needs and requests, and customer background information necessary to provide an engaging customer experience.

GAMMA implements a number of interfaces to suppliers to meet their needs. These include a full web based interactive view, communication via email with GAMMA both sending and receiving messages, a voice interface, and an assisted human interface where an administrator can assist in the communications.

GAMMA also implements customer interfaces. The first is an interface that allows customers to sign up for events or register interest in future events. This interface includes e-commerce component to directly process payments. Another customer interface is the show system. Group travel is often marketed at shows and the system provides a special interface to describe, demonstrate, and schedule potential customers with the assistance of staff at a trade show booth.

After the sale, GAMMA provides a preparation and compliance tool for customers to learn more details and provide required documentation. This includes a document upload facility to gather required customer documents, including for international travel. Another customer interface is provided post-travel which summarizes the trip, describes results, and allows posting of customer photos and the appropriate social sharing. This provides the customer with an added benefit and promotes future business.

The GAMMA system maintains a customer database and is able to communicate announcements of new events to selected customers or a mailing list. A guide or subject matter expert can selectively manage lists of prospects for each event and can search a database of previous and potential customers to offer specific events to the right group of people (e.g., based on previous trips or interests).

The suppliers in GAMMA are trusted members of the team delivering the event but are not always employees. Instead, they are selected to be experts on their specific deliverable. For instance, hotels and charter flights are operated by individual companies, often under a contract or service agreement negotiated outside the system. To provide their services they need simple specific information, and as trusted suppliers, they can sometimes work off of a single email or phone notification. It is also feasible to allow suppliers multiple GAMMA interfaces depending on supplier connectivity or preferences.

Central to the operations of GAMMA is a powerful identity management system with profiles and the definition of user roles. All users initially start with accounts equivalent to the customer role. From there, users with administrator credentials can assign users to a variety of roles, including suppliers, hosts, staff, etc. In addition, users can be assigned temporary credentials by the function they are performing; for instance, a user assisting with a trip may receive availability of information during the event that can be broader than access to historical information when the user is not acting in a role currently on a trip with customers.

Each user has a user defined profile, which can include detailed and confidential personal information and user preferences. Users can set their own security and privacy preferences within their profile. Historical information from past events remains in the user records to permit effective generation of user web pages.

In order to maintain a level of quality clients may be accustomed to, a technical solution was conceived to address one or more of the problems or limitations mentioned in the Background section above, among other things. Conventional software and systems in the marketplace were not satisfactory to meet the needs of a travel provider seeking to provide excellent customer service while reducing the amount of manual work needed to accommodate clients. Further, some conventional solutions do not provide technical features to accommodate the fluid nature of travel such as pandemics, disasters, etc. or even the simpler dynamics of changing customer schedules or work commitments. Some implementations of the disclosed subject matter were conceived to address the limitations of conventional system and provide the functionality and feature sets not only appropriate for a travel provider such as a charter fishing travel provider, but amenable to automating any group-oriented fishing, hunting or adventure travel business as well.

Client satisfaction and ease of use were important considerations along with providing an up-to date technology infrastructure and interface to automate and enhance the administrative process and address the technical problems mentioned above.

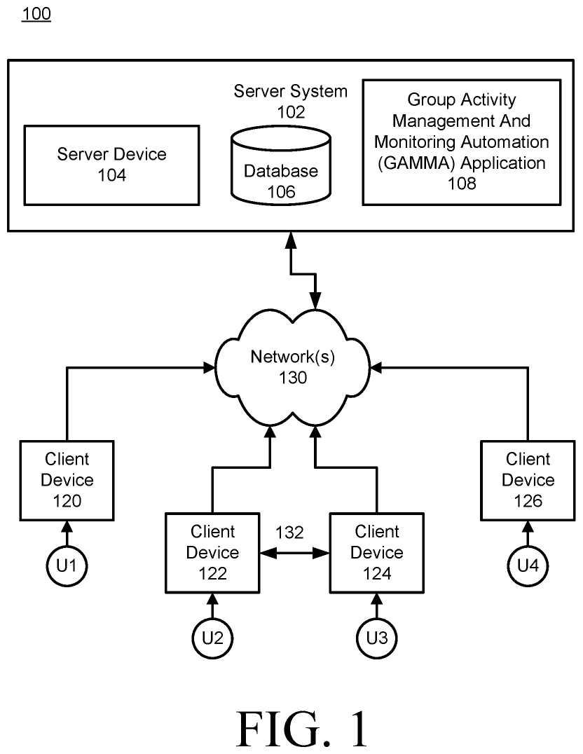

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104 and a database 106 or other data store or data storage device. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide computer-implemented methods, systems and computer readable media for Group Activity Management And Monitoring Automation (GAMMA) functions as described herein.

Various implementations of features described herein can use any type of system and/or service. Any type of electronic device can make use of features described herein. Some implementations can provide one or more features described herein on client or server devices disconnected from or intermittently connected to computer networks.

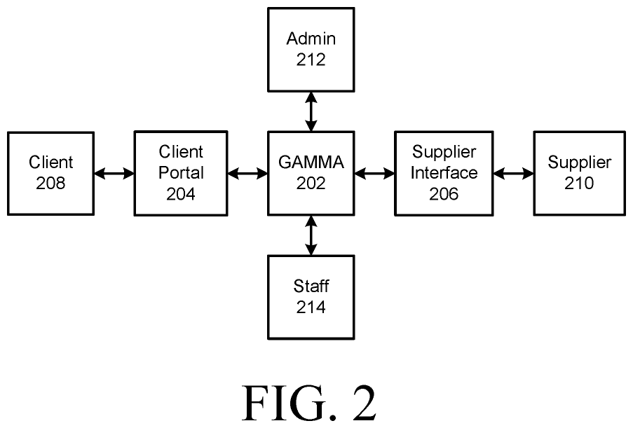

FIG. 2 is a diagram showing an example GAMMA system and client, supplier, administrator, and staff interfaces in accordance with some implementations. In particular, FIG>2 shows a GAMMA system 202 having a client portal interface 204, a supplier interface 206, and interfaces for administrators 212 and staff 214. In some implementations, the GAMMA system 202 can include one or more of the each of the interfaces 204, 206, 212, and 214.

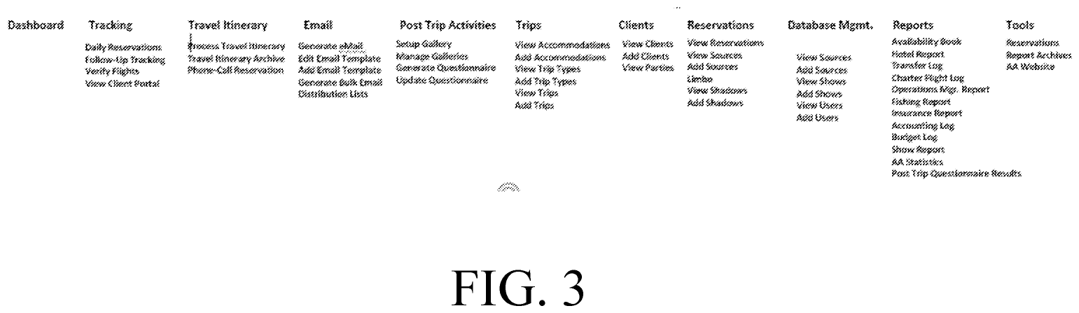

In operation, administrators 212 and staff 214 can interact with GAMMA 202 to configure, operate, and perform group activity tasks as described herein. For example, GAMMA 202 provides an admin dashboard (shown in FIG. 3 and described below).

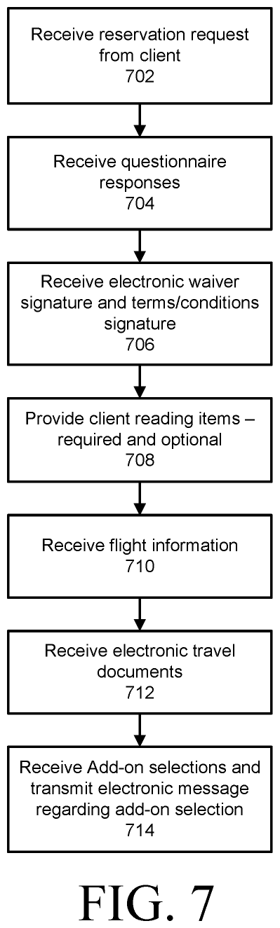

Further, the client portal 204 permits one or more clients 208 to access GAMMA for client functions such as boking a trip or completing client requirements for a trip. The client portal 204 can include a web interface for client to access GAMMA 202 via the Internet or other wired or wireless network. Client portal functions are show in greater detail in FIG. 7 and described below. GAMMA 202 can also communicate with clients 208 via email, text message, or other suitable channels.

Also, the supplier interface(s) 206 of GAMMA 202 provide a multi-channel bidirectional communication system for communication between GAMMA 202 and one or more suppliers 210. The supplier interface can include one or more channels such as email, web portal, physical mail, telephone, facsimile, human operator, web interface (e.g., web service, etc.), or software channel (e.g., application programming interface or API, etc.).

FIG. 3 is a diagram of an example administrative (or admin) dashboard 300 for a GAMMA system in accordance with some implementations. The admin dashboard 300 can include functional sections such as Tracking, Travel Itinerary, Email, Post Trip Activities, Trips, Clients, Reservations, Database Management, Reports, and Tools.

In some implementations, the Tracking section can include a Daily Reservations option to provide a listing of the daily reservations booked with their current status. This report can also provide the ability to contact the clients via email to follow-up on their trip status. The Tracking section can also include Follow-up Tracking, which is configured to provide follow-up tracking of a client's progress on their portal. This can also de done via the Reservation Package Report (RPR) which tracks the status of each task and can be accessed by an Admin or an Assistant, for example. The Tracking section can further include a Verify Flights option to manually (e.g., via admin staff manually checking flight information online or via phone) or automatically (e.g., via API connection with airline or other flight database) verify client flights to help ensure that the client is on a flight that fits with the travel event itinerary. The Tracking section can also include a function to View Client Portal, which from the Admin Dashboard, an Admin will be able to actually access the active client portals so that he/she can view the current status and activity in order to help the client make updates, as required.

In some implementations, the Travel Itinerary can include a Process Travel Itinerary option to permit an admin or staff user to add flight information to a client's travel itinerary. The Travel Itinerary section can include a Travel Itinerary Archive option to view active and inactive reservations that are complete with flight information. In other words, once a reservation is complete with airline information, it moves from the Process Travel Itinerary option display to the Travel Itinerary Archive display. The Travel Itinerary section can also include a phone-call reservation option having processing that provides for those clients who do not request their flights via the portal but contacts our Travel Agent via the phone. From this screen, the user is also able to retrieve and update existing reservations.

In some implementations, the Email section can include a Generate Email option to generate an email to a client, where the email is selected from among available email templates in the GAMMA system. The Email section also includes options to edit or add email templates. The Email section can also include an option to generate a bulk email. The Email section can further include an option to manage Distribution Lists.

In some implementations, the Post Trip Activities section can include a Setup Gallery option to permit a gallery to be setup for a client, a Manage Galleries option to manage existing galleries, a Generate Questionnaire option to generate a post-trip questionnaire for a client and an Update Questionnaire for a client.

In some implementations, the Trips section can include options for View Accommodations and Add Accommodations, which includes a list of accommodations (e.g., loading or vessels) available for use on a trip. The Trips section also includes options for View Trip Type and Add Trip Type, where a Trip Type is a template for a trip and can include one or more of the following data fields:

ID—This column displays a unique sequential identifier which has been assigned by the system. It cannot be changed by the user but can be used in the Search field or the user can sort on this field in which case the records will be displayed in the order they were input.

Accommodation—The name of the accommodation which will be the value from the Name field in the Accommodations table.

Name—The name of the Trip Type and this field must be unique. Identifies both the Accommodation Name (previous field) and the location (next field) but may be a slightly abbreviated combination of the two.

Location—Identifies the location where the Accommodation operates.

Flight Type—Identifies the type of flight that will be used to transport clients to the accommodation. For example, the flight can be either a Cessna Caravan floatplane or a Twin-Engine Embraer Bandeirante.

Type of Fish—Identifies the fish that the trip is focused on catching.

Host—Name of the person who hosts/manages the Accommodation.

Single Price—Increased Price for upgraded options on the default trip.

Double Price—Default price for the trip. Note: Initially most trips were double occupancy which was the cheaper price, so the default or less expensive options are still recorded as Double Price.

Def Open—The number of seats booked by default

Color 1—Is the background color for the table columns

Color 2—Is the background color for the table headings

BG Color—Is displayed as the background color on each page

Letter—The second letter used in each Trip ID to identify the trip type (e.g., HA-01). This field must have a unique value for each trip type. The first letter in the Trip ID identifies the year.

Sort—When reports or listings are generated, determines the order in which the trip types will be displayed and must be unique.

Active—Set to “Y” or “N” depending on whether the trip type is still active. If you are on the View Active screen, only “Y” will be displayed in this field. Access View Inactive to see all the Inactive records or View All to see all the records.

Edit—This field enables a user to edit the selected Trip Type via user interface by clicking on the Edit text in the column.

The trips section can also include a View Trip and Add Trip function. Where a new trip can be added based on a Trip Type. Trips can be added individually or in a group, for example a group of trips for a particular season can be added at one time. A Trip is based on a Trip Type, which in turn references an Accommodation.

In some implementations, the Clients section includes options to View Clients, Add Clients, and View Parties. In some implementations, a client record is automatically created by the system when a user enters a reservation. In cases when a user doesn't have complete client demographic data, the Add Client option gives the user an ability to add a client and update the remaining data later. Client records that are created by the Admin may not be initially tied to a reservation. They may be entered by the Admin via the Dashboard with incomplete information if someone calls and is interested in a trip. The basic information can be added, like email or phone number so they can be contacted again or looked up if they call again. When a client record is added by the Admin, the system will identify that the client it is not a repeat client but is already in the database. Parties can include groups of clients that have a party lead.

In some implementations, the Reservations section can include an option to View Reservations, which displays the reservation table showing the current bookings, which can be searched by client name or other field. The Reservations section also includes options to View and Add Sources, which are sources of clients for bookings (e.g., other than a show, etc.). The Reservations section also include a Limbo option. If a client has a reservation which he/she does not want to take but is not sure yet what he wants to do, he can be moved to Limbo status which will remove his reservation from the database (Trips, Parties and Reservations tables) and enter his reservation information into the Limbo table. If there is still space, he can move back to the original reservation or select a new one but until he does, he has no reservations and takes up no seat bookings. Reservations can be changed to Limbo for the whole party or individual members of a party.

The Reservations section can also include options for Viewing Shadows and Adding Shadows. If a client has a reservation, but we are not sure the trip will be held, we will let the client select an alternate or Shadow trip. The client will now have 2 reservations, one in the original trip and one in the Shadow trip. Both are displayed in the Availability Book (AVB) and updated in the trip count. Shadow Reservations can be made for the whole party or individual members of a party.

If it is determined that the client can keep their original reservation, the Shadow reservation and associated trip count is removed from the database and the original reservation becomes the actual reservation. Only the original reservation is listed in the AVB.

If it is determined that the client will take the Shadow Trip, the original reservation and trip count is removed from the database and the Shadow reservation becomes the actual reservation. Now only the updated Shadow reservation is listed in the AVB. A subsequent shadow reservation can be made based on the new actual reservation if the travel company or the client need to move the trip reservation again. Shadow trips permit the client to keep a trip in the database for a future time and to have the deliverables reserved for both the original trip and the shadow trip until a decision is made. The shadow trip process provides advantages in that by permitting a client to have an original and a shadow trip, a trip can effectively be reschedule with minimal admin or staff time and also a reduced burden on computing resources in that the shadow reservation can be accepted and the reservation moved with a reduced computation and data communication burden compared to conventional solutions.

In some implementations, the Database Management section can include options to View or Add Shows (e.g., events where travel is marketed), and to View and Add Users and Set or Modify permissions of users within the GAMMA system.

In some implementations, the Reports section can include one or more of the following reports:

| Report | Description |
|---|---|
| Availability | Provides a listing of the current bookings and open seats |
| Book (AVB) | for each trip |
| Hotel Report | Provides a listing of the hotel bookings for each day. |
| Transfer | Provides a listing of the airport transfers for each day. |
| Log | Transfers will include both arriving and departing flights |
| Charter | Provides a listing of the Charter Flights required each day |
| Flight Log | for each trip type |
| Operations | Provides the client detail for each trip including health |
| Mgr. Report | issues, preferences and requests. This report can be |
| | updated |
| Insurance | Generated weekly by the system to provide a listing of all |
| Report | the anglers who have opted into the Insurance Plan |
| Budget Log | Provides a listing of the allocated budget for each |
| | Operations Manager |
| Accounting | Provides a listing of the expenses which have been applied |
| Log | to the budget for each Operations Mgr. This report can be |
| | edited by the Admin |
| Show | Provides the booking results and statistics for each show |
| Results | |
| AA | Provides statistics on the total booking made and statistics |
| Statistics | allocated to booking categories and sources |
| Post Trip | Provides a listing of the Post Questionnaire Results |
| Question- | identified by the clients |
| naire Results | |

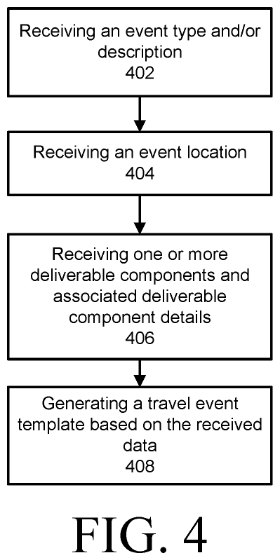

FIG. 4 is a flowchart of an example travel event (or trip) template creation process using a GAMMA system in accordance with some implementations. Processing begins at 402, where an event type and/or description is received. Processing continues to 404.

At 404, an event location is received. Processing continues to 406.

At 406, specification for one or more deliverable components is received. The specification can also include details or requirements for the corresponding deliverable component. Processing continues to 408.

At 408, a travel event template is generated based on the revied data. In some implementations, as described above, a template can include a Trip Type.

In some implementations, a GAMMA system is configured to expedite end-to-end travel processes starting when a client books a trip through to the trip implementation and post trip follow-up. Some implementations can include the following process steps:

Trip Availability is displayed to the clients on a Website and to the Admin via an Availability Book Report.

Reservations are booked on-line either by an Admin or rep via the GAMMA Reservation Package or by the client's themselves via their personal portal, if they have already booked a trip, or via the Website.

GAMMA generates email messages to confirm each reservation, which is either reserved as Tentative or Confirmed.

When a reservation is “Confirmed” GAMMA creates a personal on-line portal for each angler and sends an email notification to the client when this is set up. Instructions are included on the portal and the client is required to complete a set of pre-defined deliverables on the portal.

Airline reservations can be made via our Travel Agency or by the anglers themselves and will be entered into the portal. All reservations must be verified by an Admin (or via automatic verification process) before the trip to ensure they are correct.

The Admin can track each client's progress on the portal and follow-up, as required to ensure that all the required tasks are completed before the trip.

Information input on the client portal will be maintained in the database and sent to the appropriate staff in country or on location of travel:

The number of hotel rooms for each angler along with their arrival and departure dates will be calculated and sent to the hotel.

The traveler's heath and diet problems and/or personal preferences will be sent to the Operations Manager in country, so they are able to properly prepare for each client.

Each client will be informed of their transfer agent before their trip.

The transfer agents will be informed of each client's travel itinerary and the system will generate a schedule of the airline arrivals and departures that must be picked up at the airport.

A schedule for the Charter flights along with the client manifesto on each will be available to both the airlines and the transfer agents.

Following the trip, each client will be sent an email invitation to setup a Photo Gallery and complete a Post Trip Questionnaire via their portal. They will also be able to book an additional trip or provide a reference via their portal.

Using the database, the following additional reports are available to track the following:

A listing of the daily reservations booked with their current status. This report also provides the ability to contact the clients via email to follow-up on their trip status.

The seasonal budget for each trip type and an associated accounting log recording all the expenses generated against each trip type.

The number of anglers, the number and percentage who are new or returning customers, and the means by which their reservations were made.

The number of reservations booked at each show and the final status of each (tentative, confirmed or cancelled).

The number of fish caught on each trip.

The client's satisfaction with their trip.

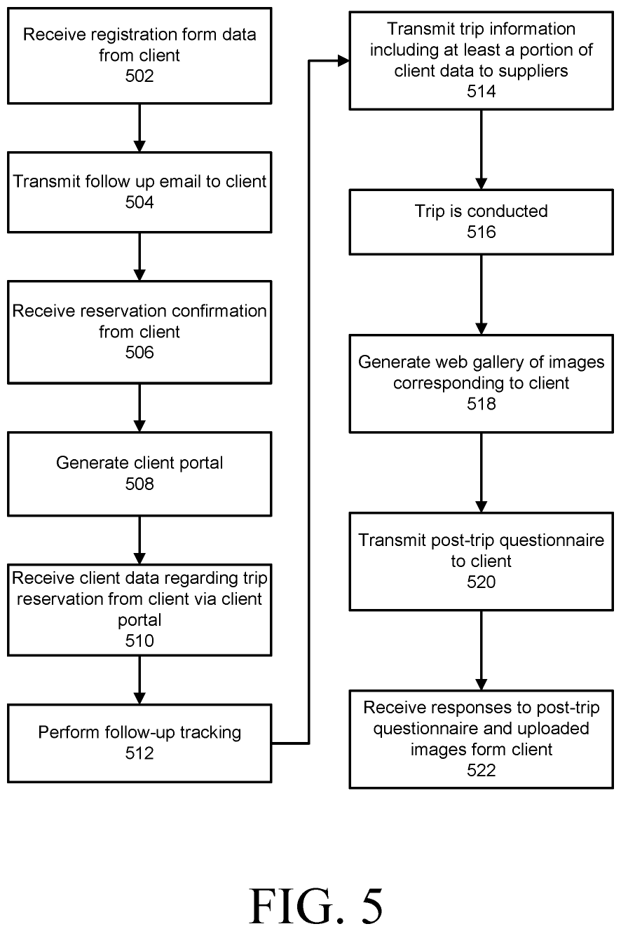

FIG. 5 is a flowchart of an example automated travel process using a GAMMA system in accordance with some implementations. Processing begins at 502, where registration data is received from a client. The registration information can include trip type, trip dates, client name, whether repeat client or not, number in party, cabin or accommodation type, etc. Processing continues to 504.

At 504, a follow-up email is sent to the client to confirm the reservation. Processing continues to 506.

At 506, a reservation confirmation is received from the client (e.g., via email or portal input). Processing continues to 508.

At 508, a client portal is generated for the client. The client portal can include one or more of the items and processes described herein (e.g., FIG. 7 and corresponding description). Processing continues to 510.

At 510, client data regarding the reservation is received via the client portal. The client data can include client demographic, physical, or other information, signed waivers, acknowledgement and agreement to terms and conditions, required reading completion, travel documents, etc. Processing continues to 512,

At 512, follow-up tracking is performed. The follow-up tracking ensures that the client has completed all requirements before a trip and that the client has secured air travel or other arrangements that may be prerequisite to the trip. Processing continues to 514.

At 514, trip information, including at least a portion of the client data, is transmitted to one or more supplies for the trip. For example, at a given time period before the trip (e.g., 1 week, 30 days, 60 days, etc.), client information for a trip is provided to the trusted suppliers via the communication channel preferred by the supplier. Processing continues to 516.

At 516, the trip is conducted. Processing continues to 518.

At 518, a gallery of images corresponding to the client is generated on the website. Processing continues to 520.

At 520, a post-trip questionnaire is transmitted to each client. Processing continues to 522.

At 522, responses to the post-trip questionnaires are received and stored for quality control and other purposes.

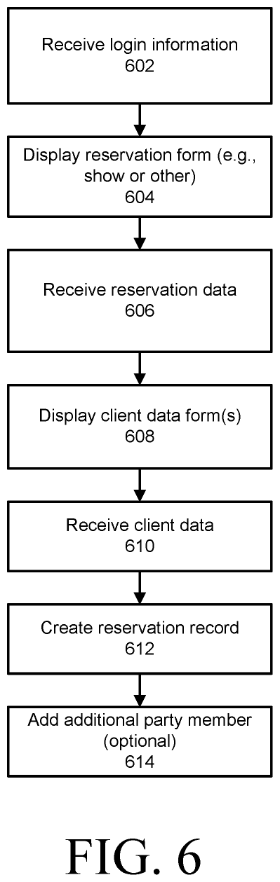

FIG. 6 is a flowchart of an example reservation process using a GAMMA system in accordance with some implementations. The reservation process begins at 602, where login information is received at the GAMMA system. Processing continues to 604.

At 604, a reservation form is displayed. For example, is the reservation is being taken at a show, a show reservation form may be displayed, otherwise, a non-show reservation form is displayed. Processing continues to 606.

At 606, reservation data is received. For example, reservation data can include trip type, trip date, number in party, accommodation preference, etc. Processing continues to 610.

At 610, client data is received. For example, client data can include client name, gender, address, phone, email address, etc. Processing continues to 612.

At 612, a reservation record is created. Processing continues to 614.

At 614, reservations for additional party members can optionally be added (e.g., via one or more of 602-612 described above).

FIG. 7 is a flowchart of an example client process for a trip using a GAMMA system in accordance with some implementations. Processing begins at 702, where a reservation request is received from a client. For example, a client can make a reservation via a web interface or a client portal (if the client is a returning client). Processing continues to 704.

At 704, client questionnaire responses are received. The questionnaire responses can include first and last name, gender, weight, emergency contact (all fields), and hotel pre-check-in info.

In some implementations, the Questionnaire contains the following sections:

Personal Information—Captures the client's personal data including an emergency contact.

Personal Preference—Includes health and diet issues and any personal preferences the client may have. This data is needed to ensure we are prepared for the client when he or she arrives.

Hotel Pre-Check-In Info—This section identifies the required rooms and rooming arrangements required at the hotel. By default, all clients will be assigned a Single Room at the hotel unless they select to share a room with another member of their party. The default option is selected by default, so no entry is required unless the client selects to share a room.

Completion—This section includes a Radio Button to indicate whether the Questionnaire has been completed. The Incomplete checkbox is checked by default and will remain checked until the client completes his/her portal. However, an Admin or Assistant has the ability to set the Questionnaire back to Incomplete if they need to get additional information from the client. Updates to the status will be made on both the report and the client portal so only set the status to Incomplete if you want the client to enter additional information on his portal. Processing continues to 706.

At 706, electronic signatures on one or more of a waiver and terms and conditions are received. These electronically signed documents can become part of the trip record of the client. Processing continues to 708.

At 708, the client can be provided with reading materials, which can include one or more required reading items and one or more optional reading items. Processing continues to 710.

At 710, flight information for the client and a given trip is received. Flight information can include airline, flight number, departure/arrival cities, seat assignments, and dates/times of flights. Processing continues to 712.

At 712, electronic travel documents are received. The electronic travel documents can include a passport number, electronic images of documents such as passport, driver's license or other government issued ID card, travel visa, etc. The travel documents are added to the client record for the trip. Processing continues to 714.

At 714, an add-on selection (e.g., an additional trip or excursion as part of an overall trip) is optionally received and an electronic message regarding the add-on selection is transmitted.

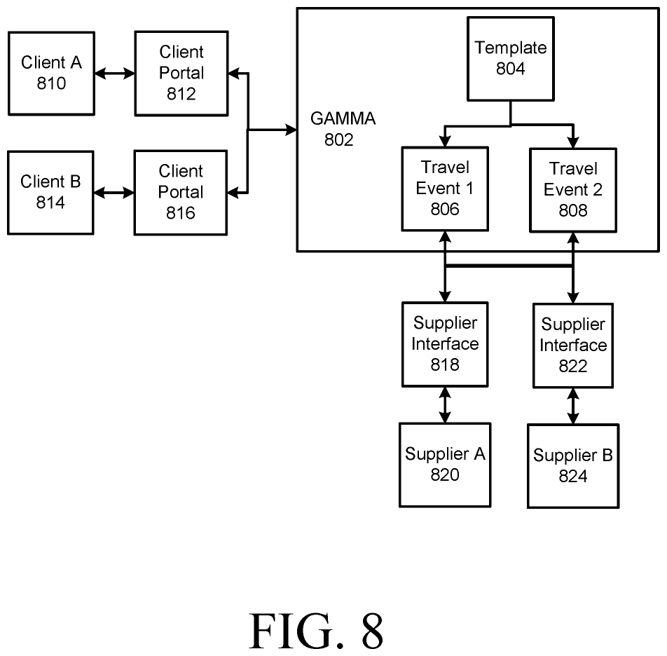

FIG. 8 is a diagram showing the automation provided by a GAMMA system between clients and suppliers for a travel event based on a template in accordance with some implementations. In FIG. 8, a GAMMA system 802 includes a trip template (or trip type) 804 that has been used to create two trips 806 and 808. Clients 810 and 814 make reservations and provide client data to the GAMMA system 802 via respective client portals 812 and 816. Around the time of the trip, the GAMMA system 802 can transmit some or all of the client data to one or more suppliers 820/824 via respective supplier interfaces 818/822. The data sent to suppliers is based on the trip data 806/808 and the client data entered through the portals 812 and 816. In some implementations, the GAMMA system 802 is able to provide booking flexibility by maintaining a database of reservations corresponding to trips, tracking availability internally, and waiting to transmit the client information for a trip near the time of the trip (e.g., with a lead time that may be required by a given supplier). It will be appreciated that two clients, two trips, and two suppliers are shown for illustration purposes. An actual implementation could have more or less of clients, suppliers, interfaces, portals, trips, trip types (or templates), etc.

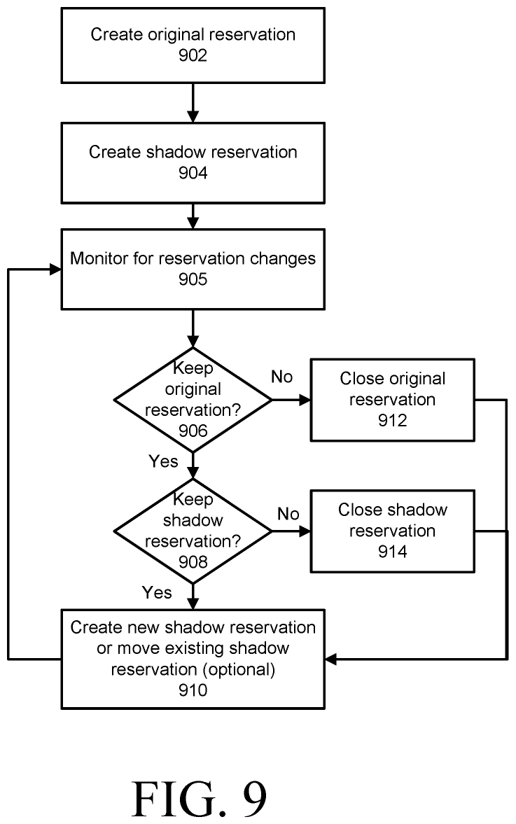

FIG. 9 is a diagram showing a shadow reservation automated process provided by a GAMMA system in accordance with some implementations. Processing begins at 902, where an original reservation is made. Processing continues to 904.

At 904, a shadow reservation is made. For example, a GAMMA user can select the original reservation and then select to create a shadow reservation from the original reservation. The shadow reservation will keep all of the information from the original reservation except for the date(s). Processing continues to 905.

At 905, the GAMMA system monitors for changes to the reservations (e.g., through the reservation user interfaces of GAMMA). Processing continues to 906.

At 906, it is determined if the original reservation is being kept by the client. If so, processing continues to 908. Otherwise, processing continues to 912 where the original reservation is dropped (or removed from the database). Processing then continues to 910.

At 908, it is determined if the shadow reservation should be kept. If so, processing continues to 910, where another shadow reservation is optionally created or the shadow reservation is moved. Otherwise, processing continues to 914 where the shadow reservation is closed or removed from the database. Processing then continues to 910 and on to 905.

In one example, the shadow reservation process can be very effective during a pandemic or other catastrophe such as the COVID-19 pandemic when travel was restricted and had to be rescheduled at scale. An implementation of the proprietary GAMMA (Group Administration Management and Monitoring Automation) software platform is configured to fully automate the business process of booking adventure fishing trips for several hundred anglers each year, usually in groups of 8-12 anglers. If a need arises to cancel a few hundred trips scheduled for due to a pandemic, and reschedule them in subsequent years, the power and benefits of GAMMA can be fully realized. Scheduling a client trip involves booking the reservation, taking payments, scheduling international air travel and private charters, hotel reservations and transport services, providing travel and rescue insurance, provisioning at each site for each trip, among other things. With conventional solutions, all of these providers would need to be contacted individually and arrangements would need to be made (based on availability) to cancel their existing reservations and rebook same at some point in the future. To do this would take up to an hour or more per angler. An implementation of GAMMA is able to automatically do this in real time enabling clients to be re-booked in only several minutes. This is a significant savings in time and energy and also eliminated the risk of human error. Turnkey rescheduling is provided by enabling the client to book a tentative new shadow reservation but to also keep the existing reservation until a decision can be made on which trip is best for the client. Future shadow trips are booked automatically via GAMMA based on availability and reservations can be made for individual clients or whole groups. And when the decision is made, just one click will change to the new reservation or keep the client(s) in their existing reservation.

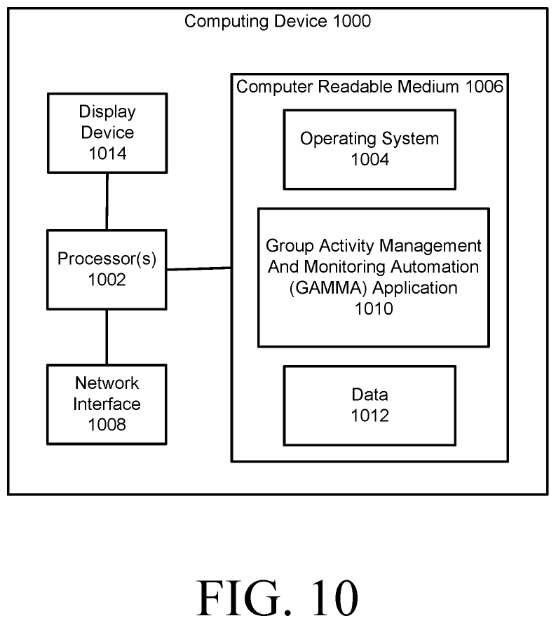

FIG. 10 is a diagram of an example computing device 1000 in accordance with at least one implementation. The computing device 1000 includes one or more processors 1002, nontransitory computer readable medium 1006 and network interface 1008. The computer readable medium 1006 can include an operating system 1004, a Group Activity Management And Monitoring Automation (GAMMA) application 1010 and a data section 1012 (e.g., for storing group activity information such as client profiles, supplier profiles, subject matter expert profiles, activity archival records, activity templates, etc.).

In operation, the processor 1002 may execute the application 1010 stored in the computer readable medium 1006. The application 1010 can include software instructions that, when executed by the processor, cause the processor to perform operations to provide computer-implemented methods, systems and computer readable media for Group Activity Management And Monitoring Automation (GAMMA) functions in accordance with the present disclosure (e.g., performing associated functions described above and shown in FIGS. 2-9).

The computer-implemented methods, systems and computer readable media for Group Activity Management And Monitoring Automation (GAMMA) application program 1010 can operate in conjunction with the data section 1012 and the operating system 1004.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules) may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general-purpose computer, a special purpose computer, a microprocessor, a network server or switch, or the like.

It is, therefore, apparent that there is provided, in accordance with the various embodiments disclosed herein, computer-implemented methods, systems and computer readable media for Group Activity Management And Monitoring Automation (GAMMA).

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A computer-implemented method comprising:
obtaining, at a group activity management and monitoring automation system, a service template specifying one or more deliverable components, wherein each of the one or more deliverable components includes one or more of a provider, a provider class, a description, and one or more parameters of that deliverable component;
generating, at the group activity management and monitoring automation system, an event record based on the service template, wherein the event record corresponds to an event and includes a specification of the one or more deliverable components from the template and a date range of the event;
storing, using the group activity management and monitoring automation system, the event record;
associating, at the group activity management and monitoring automation system, a service provider with one of the one or more deliverable components of the event;
receiving, at the group activity management and monitoring automation system, a customer record including profile information;
generating, using the group activity management and monitoring automation system, a reservation for the event associated with the customer record;
storing, using the group activity management and monitoring automation system, the reservation for the event; and
transmitting, from the group activity management and monitoring automation system, at least a portion of the customer record to the service provider to permit the service provider to provide one of the one or more deliverable components during the date range of the event.

2. The computer-implemented method of claim 1, wherein the one or more deliverable components can each include one or more of a service or a product.

3. The computer-implemented method of claim 2, wherein the one or more deliverable components can each include one or more of a sales agent service, a booking agent service, a customer interface service, a travel agency service, a hotel service, an airport ground transportation service, a vehicle service, a camp service, a catering service, a housekeeping service, a guide service, a host service, equipment, a permitting service, a concierge service, a financial service, an insurance service, and a legal service.

4. The computer-implemented method of claim 1, wherein receiving the customer record further comprises:
providing, from the group activity management and monitoring automation system, a customer portal configured to accept data for the customer record and display data from the customer record,
wherein the customer record includes one or more of data representing the customer profile, questionnaire answers, signed waivers, and an acknowledgement of terms and conditions.

5. The computer-implemented method of claim 1, further comprising:
providing, at the group activity management and monitoring automation system, a bidirectional communication system to permit the service provider to communicate with the group activity management and monitoring automation system to access the customer record and to provide status and completion information corresponding to the event.

6. The computer-implemented method of claim 5, wherein the bidirectional communication system includes one or more of email, portal, physical mail, telephone, human operator, or web interface.

7. The computer-implemented method of claim 1, further comprising:
providing, from the group activity management and monitoring automation system, a management dashboard configured to provide a dashboard user interface of one or more data items within the group activity management and monitoring automation system corresponding to one or more events, suppliers, or customers.

8. The computer-implemented method of claim 1, wherein the group activity management and monitoring automation system is configured to store financial, administrative, and legal information related to a customer, a supplier, or an event in a database of the group activity management and monitoring automation system.

9. The computer-implemented method of claim 1, wherein generating an event record based on the service template is performed one or more times based on a schedule or on demand, wherein the group activity management and monitoring automation system determines a capacity for events and permits event records to be generated for which there is a sufficient capacity of deliverable components to meet requirements of the generated event records.

10. The computer-implemented method of claim 1, further comprising:
providing, from the group activity management and monitoring automation system, a listing of services offered and corresponding descriptions via a customer facing user interface.

11. The computer-implemented method of claim 1, further comprising:
receiving, at the group activity management and monitoring automation system, an electronic payment for the event, wherein the electronic payment can include a partial payment or a full payment for an event or service for one or more customers.

12. The computer-implemented method of claim 1, further comprising:
generating, using the group activity management and monitoring automation system, a plurality of reservations each for a respective customer of a plurality of customers, wherein the reservations are associated with the event record; and
forming, using the group activity management and monitoring automation system, a group reservation including the plurality of customers and corresponding reservations.

13. The computer-implemented method of claim 1, further comprising:
assigning, using the group activity management and monitoring automation system, a confirmed status to the reservation.

14. The computer-implemented method of claim 12, further comprising:
assigning, using the group activity management and monitoring automation system, a confirmed status to the group reservation.

15. The computer-implemented method of claim 1, further comprising:
assigning, using the group activity management and monitoring automation system, a tentative status to the reservation, wherein the one or more deliverable components are reserved based on the tentative reservation; and
when the customer indicates confirmation of the tentative reservation, updating the reservation status to confirmed.

16. The computer-implemented method of claim 12, further comprising:
assigning, using the group activity management and monitoring automation system, a tentative status to the group reservation, wherein the one or more deliverable components are reserved based on the tentative group reservation; and
when the customer indicates confirmation of the tentative group reservation, updating the group reservation status to confirmed.

17. The computer-implemented method of claim 1, further comprising:
assigning, using the group activity management and monitoring automation system, a limbo status to the reservation, wherein the one or more deliverable components are not reserved based on the limbo reservation; and
when the customer indicates confirmation of the limbo reservation, updating the reservation status to confirmed and reserving the one or more deliverables if available for the event date range.

18. The computer-implemented method of claim 12, further comprising:
assigning, using the group activity management and monitoring automation system, a limbo status to the group reservation, wherein the one or more deliverable components are not reserved based on the limbo group reservation; and
when the customer indicates confirmation of the limbo group reservation, updating the group reservation status to confirmed and reserving the one or more deliverable components if available during the date range of the event corresponding to the limbo group reservation.

19. The computer-implemented method of claim 5, further comprising:
creating, using the group activity management and monitoring automation system, a shadow reservation, for an individual customer or a group, wherein the shadow reservation is based on an original reservation, wherein the shadow reservation includes reservation details of the original reservation with a different date range from the original reservation;
maintaining, in the group activity management and monitoring automation system, the original reservation and the shadow reservation;
receiving, at the group activity management and monitoring automation system, an indication of a selection of the original reservation or the shadow reservation as a selected reservation;
when the original reservation is the selected reservation:
keeping, at the group activity management and monitoring automation system, the original reservation in the group activity management and monitoring automation system; and
discarding, at the group activity management and monitoring automation system, the shadow reservation;
when the shadow reservation is the selected reservation:
making, at the group activity management and monitoring automation system, the shadow reservation a confirmed reservation and updating a status of the shadow reservation from shadow to confirmed;
cancelling, at the group activity management and monitoring automation system, the original reservation; and
transmitting, from the group activity management and monitoring automation system, via the bidirectional communication system, a change notice to any suppliers associated with the one or more deliverable components indicating a change from the original reservation to the shadow reservation.

20. The computer-implemented method of claim 1, further comprising:
receiving, at the group activity management and monitoring automation system, from a subject matter expert, event data including one or more of an event type, an event location, a customer type, and identification of one or more deliverable components and associated deliverable component details; and
generating, at the group activity management and monitoring automation system, the event template based on the event data.
